(19) United States
(12) Patent Application Publication
(10) Pub. No.: US 2010/0321367 A1
(43) Pub. Date: Dec. 23, 2010

(54) DISPLAY DRIVER AND THRESHOLD VOLTAGE MEASUREMENT METHOD

(75) Inventor: Yoshihiro Shona, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/792,061

(22) Filed: Jun. 2, 2010

(30) Foreign Application Priority Data
Jun. 18, 2009 (JP) 2009-144992

(51) Int. Cl. G09G 5/00

(52) U.S. Cl. 345/211

(57) ABSTRACT

A display driver drives a display in which each pixel includes a light-emitting element, a transistor that supplies current to the light-emitting element, and a capacitor that controls the transistor. To determine the threshold voltage of the transistor, the display driver charges the capacitor to an initial voltage, then allows the capacitor to discharge through the transistor, measures the time that elapses until the capacitor reaches a reference voltage intermediate between the initial voltage and the threshold voltage, and calculates the threshold voltage from the elapsed time. This measurement method is quick and does not require an analog-to-digital converter. The measured values are used to generate correction data to compensate for threshold voltage shifts.

### BACKGROUND OF THE INVENTION

1. Field of the Invention

The present invention relates generally to a driving apparatus for a display device such as an active matrix organic light emitting diode display panel, and in particular to an improved method of measuring the threshold voltages of driving transistors in the display device.

2. Description of the Related Art

In an active matrix organic light emitting diode display panel, also referred to as an electroluminescent display panel, and in other display panels of the self-emission type, each pixel generally includes a light emitting element, a capacitor, and a driving transistor that supplies current to the light emitting element in an amount controlled by the capacitor voltage. The light emitting element emits light with a brightness that depends on the amount of current supplied, therefore depending on the capacitor voltage. The pixel also includes switching transistors used to control the charging of the capacitor.

The switching and driving transistors are normally single channel amorphous silicon thin-film transistors (TFTs), which can be formed easily and have uniform operating characteristics. Unfortunately, TFTs are known to undergo a significant threshold voltage shift over time, dependent on their drive history. If the threshold voltage of the driving transistor shifts, the current supplied to the light emitting element does not correspond correctly to the capacitor voltage, so the intended brightness is not obtained.

To solve this problem, in Japanese Patent Application Publication No. 2006-301250 Shirasaki et al. disclose a display driver that uses an analog-to-digital converter (ADC) to measure the threshold voltages of the driving transistors in all of the pixels before beginning display operations, creates correction data for each pixel on the basis of the measured values, adds voltages corresponding to the correction data to the voltages corresponding to the display data, and charges the capacitors to the resulting corrected voltages.

Although the correction data fix the problem of threshold voltage shift in amorphous silicon TFTs, the measurement process described by Shirasaki et al. takes much time, because it is necessary to wait for the data signal lines in the display panel to converge to the threshold voltages being measured, and the ADC takes up much space, increasing the size and cost of the driver chip.

### SUMMARY OF THE INVENTION

A general object of the present invention is to reduce the size and cost of a display driver.

A more specific object of the invention is to reduce the size and cost of a display driver for a display panel using amorphous silicon thin-film transistors.

Another object is to shorten the time necessary before the display driver can begin display operations.

The invention provides a novel method of measuring the threshold voltage of a driving element in a pixel including the driving element, a light emitting element that receives current from the driving element, and a capacitor that controls the driving element. The novel method includes:

charging the capacitor to an initial voltage that turns on the driving element;

allowing the capacitor to discharge through the driving element;

measuring the time that elapses until the capacitor voltage reaches a reference voltage intermediate between the initial voltage and the threshold voltage; and

calculating the threshold voltage from the elapsed time.

The invention also provides a novel method of driving the pixel that includes measuring the threshold voltage of the driving element by the novel method, using the measured threshold voltage to correct a gradation voltage, and charging the capacitor to the corrected gradation voltage.

The invention further provides a novel display driver for driving the pixel. The novel display driver includes an output terminal connected to the capacitor, an initial voltage generator for supplying the initial voltage from the output terminal to the capacitor, a measurement circuit for measuring the time that elapses until the output terminal reaches the reference voltage after supply of the initial voltage stops, and a threshold voltage calculator for calculating the threshold value of the driving element from the elapsed time.

The measurement circuit may include a comparator for comparing the output terminal voltage with the reference voltage, and a counter for counting time under control of the comparator.

Alternatively, the novel display driver may include a voltage follower that drives the output terminal, and the measurement circuit may include switches for supplying the reference voltage to the voltage follower and disconnecting the output of the voltage follower from the output terminal, enabling the voltage follower to function as a comparator that compares the output terminal voltage with the reference voltage. The measurement circuit also includes a counter for counting time and a latch for latching the counter value under control of the voltage follower output.

The novel display driver and method save time in threshold voltage measurement because it is only necessary to wait for the data signal lines to reach a reference voltage intermediate between the initial voltage and the threshold voltage, instead of waiting until the threshold voltage itself is reached. Space is saved because elapsed time is measured with a counter and the threshold voltage is calculated from the elapsed time, without using an ADC. Additional time and space can be saved by using the voltage follower that drives each output terminal as a comparator and measuring the threshold voltages in an entire row of pixels simultaneously.

### BRIEF DESCRIPTION OF THE DRAWINGS

In the attached drawings:

FIG. 1 is a schematic block diagram illustrating a display panel and its driving circuits;

FIG. 2 is a schematic block diagram illustrating some of the driving circuits and one pixel in FIG. 1 according to a first embodiment of the invention;

FIG. 3 is a graph illustrating the threshold voltage measurement principle according to the invention;

FIG. 4 is a schematic block diagram illustrating a conventional display driver;

FIG. 5 is a graph illustrating the threshold voltage measurement principle in FIG. 4; and

FIG. 6 is a schematic block diagram illustrating some of the driving circuits and one pixel in FIG. 1 according to a second embodiment of the invention.

### DETAILED DESCRIPTION OF THE INVENTION

Embodiments of the invention will now be described with reference to the attached non-limiting drawings, in which like elements are indicated by like reference characters.

### First Embodiment

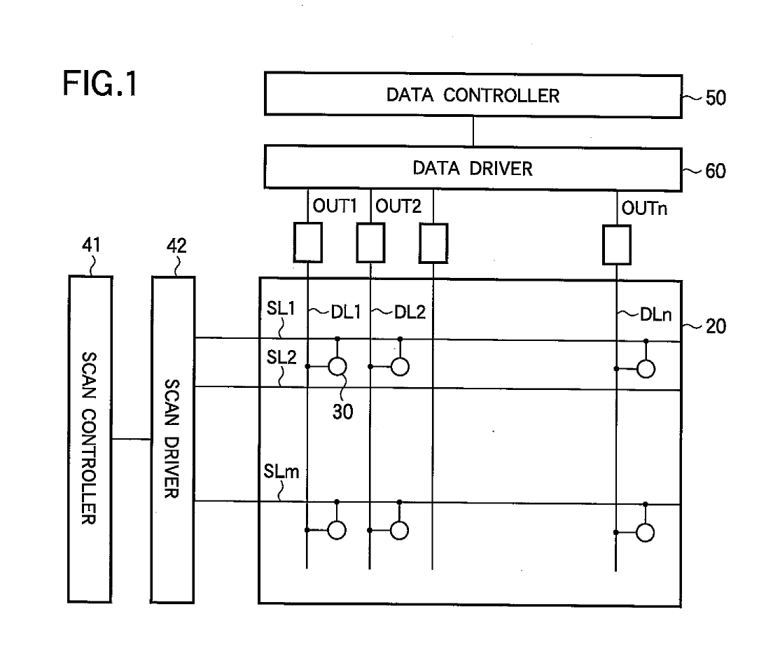

Referring to FIG. 1, the first embodiment is part of a display device having a display panel 20 with mutually parallel selection lines SL1 to SLm extending in the row direction (the horizontal direction in the drawing), mutually parallel data lines DL1 to DLn extending in the column direction (the vertical direction in the drawing), and a matrix of pixels 30 placed near the points where the data lines cross the selection lines.

The data lines DL1 to DLn are connected to a data driver 60 via respective output terminals OUT1 to OUTn. The data driver 60 is controlled by a data controller 50 to generate gradation voltages and supply the gradation voltages from the output terminals to the data lines. The data controller 50 and data driver 60, including the output terminals OUT1 to OUTn, constitute the novel display driver in the first embodiment. The selection lines SL1 to SLm are connected to a scan driver 42, which outputs scan signals to the selection lines SL1 to SLm under the control of a scan controller 41.

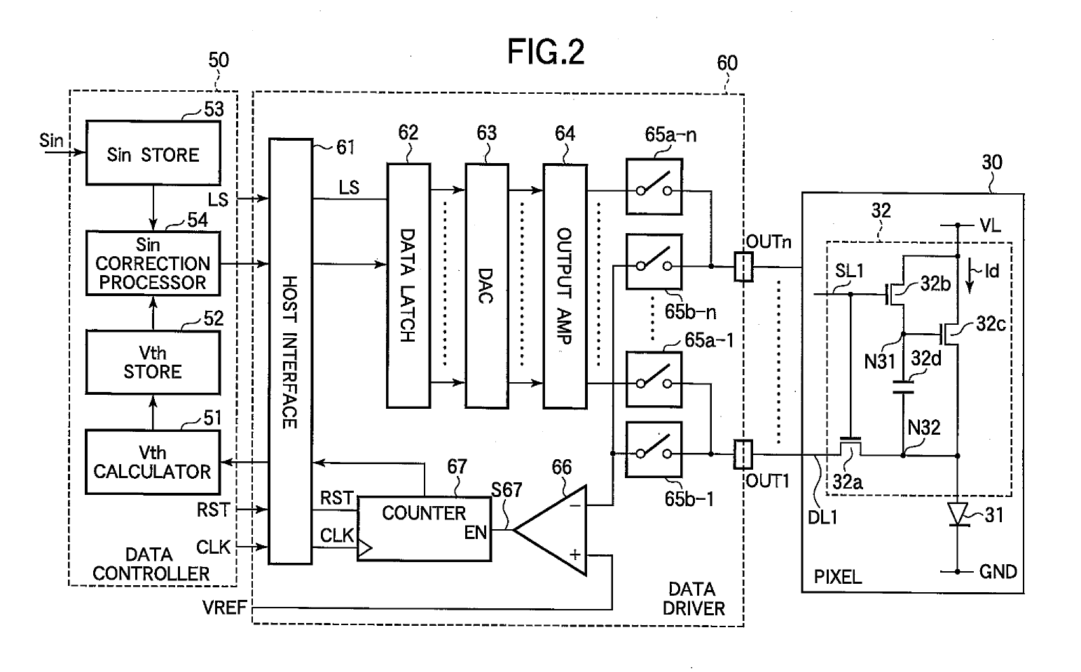

FIG. 2 shows the internal structure of the data controller 50, the data driver 60, and one representative pixel 30.

The pixel 30 in FIG. 2 is connected to the first selection line SL1 and first data line DL1. The pixel 30 includes a light emitting element 31 such as, for example, an organic light emitting diode, and a pixel driving circuit 32 that drives the light emitting element 31. The pixel driving circuit 32 includes switching transistors 32a, 32b, a driving transistor 32c, and a capacitor 32d for storing a gradation voltage. Switching transistor 32a has a gate connected to selection line SL1, a drain connected to data line DL1, and a source connected to a node N32. Switching transistor 32b has a gate connected to selection line SL1, a drain connected to a supply voltage line VL, and a source connected to a node N31.

The driving transistor 32c has a control terminal or gate connected to node N31, a drain connected to the supply voltage line VL, and a current output terminal or source connected to node N32. The capacitor 32d is connected between nodes N31 and N32. The light emitting element 31 has an anode connected to node N32 and a cathode connected to a common voltage line (a ground voltage line, for example, as indicated by the letters GND).

The data controller 50 comprises a threshold voltage (Vth) calculator 51 for calculating threshold voltages Vth of the driving transistors in the display panel, a threshold value (Vth) store 52 and a display data (Sin) store 53 configured as, for example, one or more memory devices or parts thereof, and a display data correction processor 54. The display data correction processor 54 adds corrections to received display data Sin stored in the display data store 53, according to the calculated threshold voltage data stored in the threshold value store 52, to compensate for threshold voltage shifts in the driving transistors, and outputs the corrected display data as gradation data to the data driver 60.

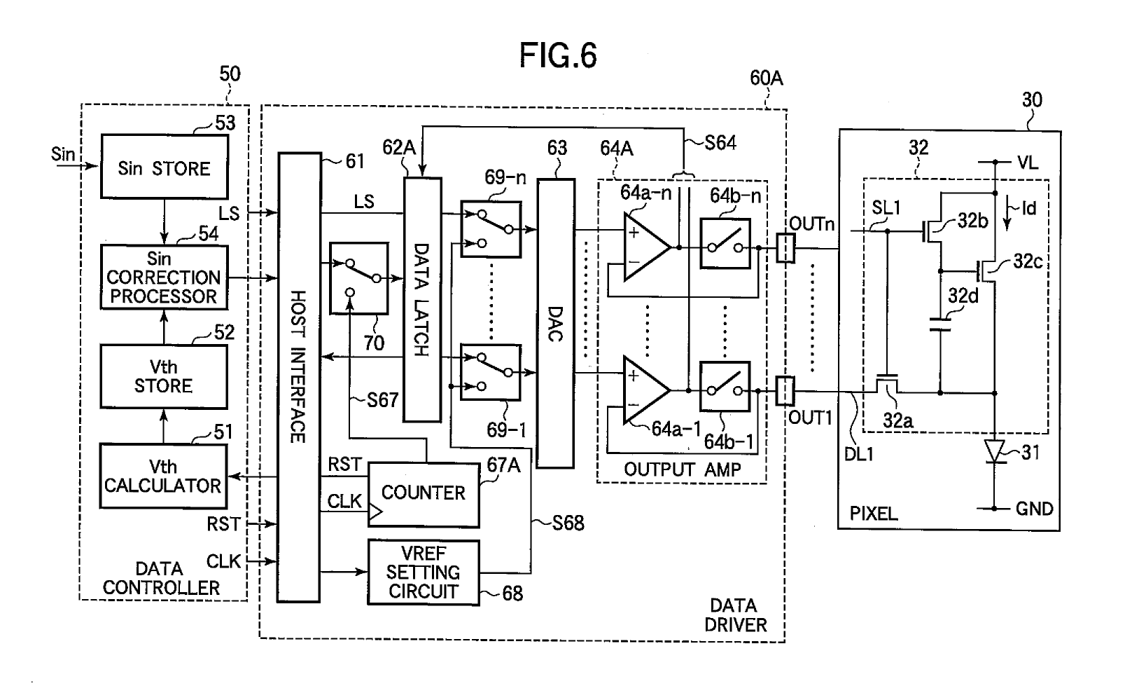

The data driver 60 has a host interface 61 for transferring control signals and data between the data controller 50 and the other circuits in the data driver 60, a data latch 62 for receiving gradation data and a latch signal LS through the host interface 61 and storing the gradation data, a digital-to-analog converter (DAC) 63 for converting the gradation data to analog signals having corresponding voltage levels, and an output amplifier 64 for outputting the voltages output from the DAC 63 to the display panel 20 as gradation voltages. The data latch 62 includes n storage cells (not shown), corresponding to the n pixels 30 in one row in the display panel. The DAC 63 and output amplifier 64 operate on the gradation data for an entire row of pixels at once. The output amplifier 64 includes n operational amplifiers configured as output followers, substantially as in FIG. 6 but without the switches 64b-1 to 64b-n shown in FIG. 6.

The output side of the output amplifier 64 is connected through a plurality of switches 65a-1 to 65a-n and the plurality of output terminals OUT1 to OUTn to the data lines DL1 to DLn of the display panel. The output terminals OUT1 to OUTn are connected through another plurality of switches 65b-1 to 65b-n to the inverting input terminal of a comparator 66. The non-inverting input terminal of the comparator 66 receives an externally supplied reference voltage VREF. The comparator 66 supplies an output signal to the enable terminal (EN) of a counter 67.

The counter 67 receives a reset signal RST and a clock signal CLK from the data controller 50 through the host interface 61 and outputs count data to the host interface 61.

During normal display operations, the display device shown in FIGS. 1 and 2 operates as follows. First, to write gradation voltages into, for example, the j-th row of pixels, the data controller 50 closes (turns on) switches 65a-1 to 65a-n in the data driver 60, opens (turns off) switches 65b-1 to 65b-n, receives the display data Sin for the j-th row from a host device (not shown), and stores the display data Sin in the display data store 53. The display data Sin are corrected in the threshold value store 52, transferred through the host interface 61, and stored as gradation data in the data latch 62. The outputs from the data latch 62 are converted by the DAC 63 to analog signals, which are output from the output amplifier 64 to the output terminals OUT1 to OUTn as gradation voltages corresponding to the corrected display data. The supply voltage line VL is set to the ground voltage level. When the scan controller 41 drives the j-th selection signal SLj to the high logic level, the switching transistors 32a, 32b in the j-th row of pixels 30 turn on, and the gradation voltages are written into the capacitors 32d.

Next, selection line SLj is driven to the low logic level by the scan controller 41, the switching transistors 32a, 32b are turned off, and the gradation voltages stored in the capacitors 32d are left as the source-gate voltages of the driving transistors 32c. Under this condition, when a pixel driving voltage is applied to the supply voltage line VL, pixel driving currents Id flow through the plurality of light emitting elements 31 in the j-th row and the light emitting elements 31 emit light with corresponding brightness levels.

As noted above, the threshold voltage Vth of a pixel driving transistor 32c shifts over time, depending on the driving history of the driving transistor 32c, so to correct the display data properly, the threshold voltages Vth of all the driving transistors 32c must be measured individually from time to time. For the pixel 30 in FIG. 2, this measurement is carried out as follows.

First, an initial voltage of, for example, −10 V is stored in the capacitor 32c of the pixel 30 by the procedure described above. Specifically, the supply voltage line VL of the display panel 20 is brought to the ground level and selection line SL1 is driven high, turning on the switching transistors 32a, 32b. The data controller 50 sends the data driver 60 gradation data specifying the initial voltage. The gradation data are converted to analog voltages by the DAC 63 and output by the output amplifier 64. From a first time to a second time, switch 65a-1 is turned on, switch 65b-1 is turned off, and the initial voltage (−10 V) is output from output terminal OUT1 onto data line DL1.

In the pixel 30, the source of the driving transistor 32c and the anode of the light emitting element 31 are driven to −10 V through switching transistor 32a, while the gate of the driving transistor 32c is held at the ground level (0 V) through switching transistor 32b. The resulting gate-source voltage (10 V) turns on the driving transistor 32c, but the light emitting element 31 is reverse biased and neither conducts current nor emits light.

Meanwhile, the counter 67 is reset by the reset signal RST, and a reference voltage VREF, for example, −5 V, is supplied from an external source to the non-inverting input terminal of the comparator 66. At the second time, switch 65a-1 is turned off and switch 65b-1 is turned on, placing output terminal OUT1 in the high-impedance state. Input of a clock signal to the counter 67 begins and the counter 67 starts counting. Since the driving transistor 32c is turned on but is cut off from the output amplifier 64, and the light emitting element 31 cannot conduct, the driving transistor 32c feeds current into the capacitor terminal connected to node N32, discharging the capacitor 32d and raising the voltage level at node N32. The data driver 60 sees this voltage rise as a rise in the voltage at output terminal OUT1.

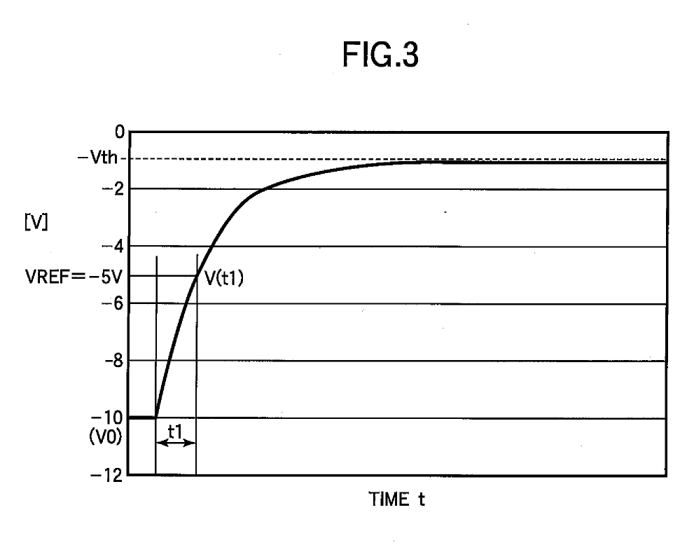

The voltage rise at the output terminal OUT1 is illustrated as a function of time (t) in FIG. 3. The rise tapers off as the gate-source voltage of the driving transistor 32c is reduced and would stop when the output terminal OUT1 reached −Vth, but the measurement is terminated shortly after the output terminal OUT1 reaches the reference voltage VREF at elapsed time t1. The light emitting element 31 remains reverse biased during this time t1 and no light is emitted.

The voltage at output terminal OUT1 passes through switch 65b-1 to the inverting input terminal of the comparator 66. As long as this voltage is lower than the reference voltage VREF, the output S67 of the comparator 66 and therefore the enable signal EN of the counter 67 remain high, causing the counter 67 to count each clock pulse it receives. When the voltage at the inverting input terminal of the comparator 66 rises above the reference voltage VREF, the output S67 of the comparator 66 and the enable signal EN go low, and the counter 67 stops counting. The counter 67 accordingly counts and measures the elapse of time from when clock input begins with output terminal OUT1 at −10 V until output terminal OUT1 reaches −5 V (the reference voltage VREF).

The counted value is read through the host interface 61 into the data controller 50, where the threshold voltage Vth is calculated by the threshold voltage calculator 51. The calculation can be carried out by using the general resistor-capacitor (RC) circuit equation that describes the charging and discharging of a capacitance C through a resistance R.

According to this equation, the voltage V(t) at output terminal OUT1 after an elapsed time t is given by the following expression (1).

V(t)=(Vth−V0)(1−exp(−αt))+V0 (1)

where,

Vth: threshold voltage

α=RC

R: sum of wiring resistance and on-resistances of transistors 32a, 32c

C: sum of wiring capacitance and capacitances of output terminal OUT1 and capacitor 32d

V0: initial voltage

Using equation (1), simultaneous equations that satisfy the conditions at t=t0 and t1 are obtained as follows.

V(t0)=(Vth−V0)(1−exp(−αt0))+V0

V(t1)=(Vth−V0)(1−exp(−αt1))+V0 (2)

From the above equations, the following equation is obtained by subtraction.

V(t1)−V(t0)=(Vth−V0)(exp(−αt0))−exp(−αt1))

Substituting t0=0, V(t0)=V0, and V(t1)=VREF gives the following equation.

VREF−V0=(Vth−V0(1−exp(−αt1))

Solving this equation for Vth gives the following expression (3).

Vth={(VREF−V0)/(1−exp(αt))}+V0 (3)

The threshold voltage calculator 51 substitutes the elapsed time indicated by the count value output by the counter 67 for t1 in expression (3) to obtain the threshold voltage Vth, and stores the obtained value in the threshold value store 52. The threshold voltages Vth of the other pixels 30 are similarly calculated and stored in the threshold value store 52. Threshold voltage information for all pixels 30 in the display panel 20 is stored in this way.

After the threshold voltage information has been stored, during normal display operations, the display data correction processor 54 corrects the display data stored in the display data store 53 by, for example, adding values proportional to the threshold value stored in the threshold value store 52, so that regardless of threshold voltage variations in the display panel 20, the light emitting elements 31 emit light with the correct brightness levels.

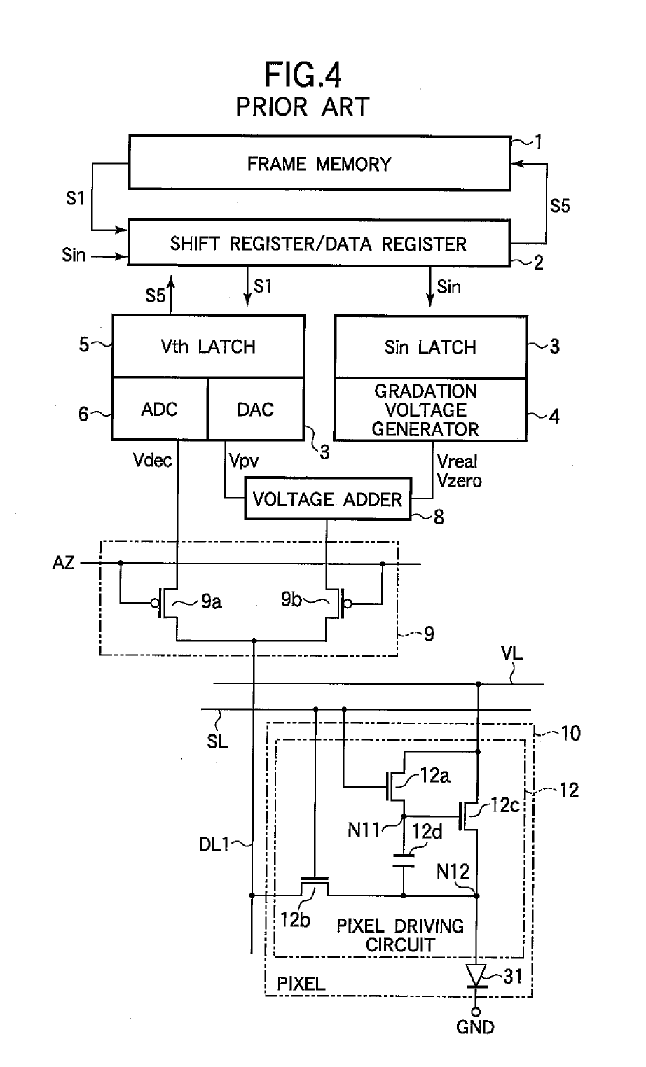

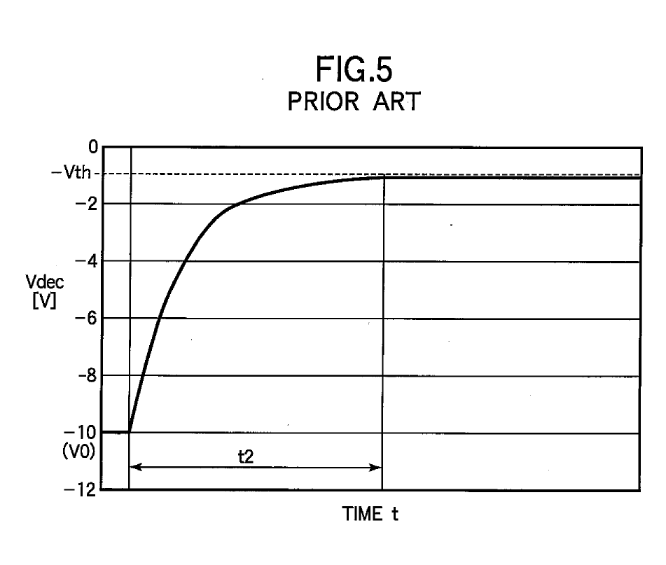

For comparison, the measurement method disclosed by Shirasaki et al. will now be briefly described with reference to FIGS. 4 and 5.

Referring to FIG. 4, the display driver described by Shirasaki et al. includes a frame memory 1, a shift register/data register 2, a display data latch 3, a gradation voltage generator 4, a threshold data latch 5, an ADC 6, a DAC 7, a voltage adder 8, and a data line input/output switch 9 with a p-channel transistor 9a and an n-channel transistor 9b, both controlled by a switch control signal or auto-zero signal AZ. The apparatus drives a display panel having a plurality of pixels 10 arranged in a matrix, each pixel including a light emitting element 11 and a pixel driving circuit 12. The pixel driving circuit 12 is configured as in the first embodiment, including switching transistors 12a, 12b, a driving transistor 12c, and a capacitor 12d. The threshold voltage Vth of the driving transistor 12c is measured as follows.

First, the auto-zero signal AZ and selection line SL are driven high and the supply voltage line VL is placed at the ground level (GND). The gradation voltage generator 4 outputs a display voltage Vzero for displaying black (no light emission) and the DAC 7 outputs a predetermined detection voltage Vpv through the voltage adder 8, data line input/output switch 9, data line DL, and transistor 12b to node N12. Capacitor 12d is quickly charged to a voltage Vcp that turns on the driving transistor 12c. A corresponding current flows onto data line DL and is sunk by the gradation voltage generator 4 and voltage adder 8.

Next, the auto-zero signal AZ and selection line SL are driven low, halting the flow of current on data line DL and leaving node N12 in the high-impedance state. The flow of current through the driving transistor 12c now discharges capacitor 12d and raises the voltage level at node N12 as shown in FIG. 5. This current flow stops when the charge left in capacitor 12d matches the threshold voltage Vth of transistor 12d. The voltage at node 112 rises rapidly at first, then more gradually, taking considerable time (t2) to converge to the threshold voltage Vth.

When convergence is complete, the selection line SL is driven high, turning on transistor 12b and transferring the threshold voltage Vth from node N12 to data line DL for input to the ADC 6 as a detected voltage Vdec. The ADC 6 converts the detected voltage Vdec to digital threshold detection data S5, which are temporarily stored in the threshold data latch 5, then read into the shift register/data register 2, stored in the frame memory 1, and used as threshold compensation data S1 for the display data Sin. In subsequent display driving operations, compensation voltages Vpv output from the DAC 7 according to the threshold compensation data S1 and gradation voltages Vreal output from the gradation voltage generator 4 according to the display data Sin are added together in the voltage adder 8, and the resulting sum is used to drive the pixel 10.

A major advantage of the first embodiment over this and other conventional methods that measure the threshold voltage directly is that the first embodiment is faster, because the rising voltage of the output terminal reaches the reference voltage used in the first embodiment (at time t1 in FIG. 3) long before it would converge to the threshold voltage Vth (at time t2 in FIG. 5). Another advantage is that the comparator 66 used in the first embodiment is much smaller than the ADC 6 in FIG. 4, so the first embodiment reduces the size of the data driver 60, leading to a reduction of driver chip size and cost.

### Second Embodiment

Referring to FIG. 6, the second embodiment eliminates the switches 65a-i, 65b-i and comparator 66 in the first embodiment and instead uses an output amplifier 64A that includes both voltage followers 64a-1 to 64a-n and switches 64b-1 to 64b-n, making it possible to use both the amplification and comparator functions of the voltage followers.

Another switch 70 is provided to enable the data latch 62A to receive either data from the host interface 61 or the count output S67 from the counter 67A. The data latch 62A also receives the output signals S64 from the voltage followers 64a-1 to 64a-n.

Switches 69-1 to 69-n are provided between the data latch 62A and the DAC 63 to select either gradation data from the data latch 62A or a reference voltage value S68 from a newly provided reference voltage setting circuit 68 for input to the DAC 63. The reference voltage value S68 is a particular gradation data value written in the reference voltage setting circuit 68 by the data controller 50 through the host interface 61. Count data stored in the data latch 62A can be output through the host interface 61 to the data controller 50.

When threshold voltages are measured, first switches 64b-1 to 64b-n are closed, switch 70 is set to select data output from the host interface 61, and switches 69-1 to 69-n are set to select data output from the data latch 62A. The counter 67A is cleared by the reset signal RST, and the reference voltage value is written through the host interface 61 into the reference voltage setting circuit 68.

In this condition, the data controller 50 stores initial voltage data in all storage cells of the data latch 62A via the host interface 61 and switch 70. The initial voltage data are input through switches 69-1 to 69-n to the DAC 63 and converted to analog voltage signals, which are supplied to the output amplifier 64A. The voltage followers 64a-1 to 64a-n in the output amplifier 64A output gradation voltages equal to these analog voltage signals through switches 64b-1 to 64b-n to charge the capacitors 32d in one entire row of pixels 30.

Next switches 64b-1 to 64b-n are opened, switch 70 is simultaneously switched to select the output of the counter 67A, switches 69-1 to 69-n are switched to select the output of the reference voltage setting circuit 68, and the counter 67A begins counting pulses of the clock signal CLK. The latch signal LS is input to the data latch 62A following each clock pulse, so that every count value can be latched in all storage cells of the data latch 62A.

The reference voltage value 568 set in the reference voltage setting circuit 68 is input to the DAC 63 and converted from a digital signal to an analog reference voltage VREF, which is input to the output amplifier 64A. Since switches 64b-1 to 64b-n are open, the voltage followers 64a-1 to 64a-n in the output amplifier 64A operate as comparators that compare the voltages at the output terminals OUT1 to OUTn with the reference voltage VREF. When the reference voltage VREF is higher than the voltage at an output terminal OUTi (i=1 to n), voltage follower 64a-i outputs a signal at the high logic level to the i-th cell in the data latch 62A, which allows the count value S67 from the counter 67A to be latched in the i-th cell in the data latch 62A in synchronization with the latch signal LS. Signal S64 in FIG. 6 represents n individual output signals from the voltage followers 64a-1 to 64a-n, which control the n cells in the data latch 62A individually by functioning as latch enable signals.

When the current outflow from transistor 32c in the i-th pixel 30 charges capacitor 32d and output terminal OUTi to a voltage higher than the reference voltage VREF, the output from voltage follower 64a-i goes low, preventing any further count values S67 from being latched in the i-th storage cell in the data latch 62A. The row measurement ends after a predetermined number of clock periods sufficient to ensure that the outputs of all n voltage followers 64a-1 to 64a-n go low. If the initial voltage is −10 V and the reference voltage VREF is −5 V, for example, then at the end of the predetermined number of clock periods the data latch 62A is left holding n count values indicating the times required for the n voltages received from the pixels 30 in one row in the display panel 20 to change from −10 V to −5 V.

The latched count values are supplied through the host interface 61 to the threshold voltage calculator 51 in the data controller 50, and threshold values Vth are calculated and stored in the threshold value store 52 as in the first embodiment.

During normal display operations, driving voltages corrected for threshold voltage shifts are output to the display panel 20 in basically the same way as in the first embodiment, with switches 64b-1 to 64b-n closed, switch 70 set to select the host interface 61, and switches 69-1 to 69-n set to select the data latch 62A.

The second embodiment provides the same effects as the first embodiment and the following additional effects.

Since the threshold voltages Vth in an entire row of n pixels 30 in the display panel 20 can be measured simultaneously, the measurement time can be reduced by a factor of n as compared with the first embodiment.

Moreover, since the voltage followers 64a-1 to 64a-n are also used as comparators, the separate comparator 66 provided in the first embodiment is unnecessary. The size of the data driver 60A and the size and cost of the driver chip can be reduced accordingly.

### Variations

The threshold voltage calculator 51, threshold value store 52, and display data correction processor 54 disposed in the data controller 50 in the preceding embodiments may be disposed in the data driver 60 or 60A instead.

Instead of using an external reference voltage VREF, the first embodiment may include switches 69-1 to 69-n and a reference voltage setting circuit 68 as in the second embodiment, enabling an output from the DAC 63 to be used as the reference voltage VREF.

The pixel driving circuit is not limited to the circuit configuration shown in the drawings.

The mathematical model used to calculate the threshold value need not be an RC circuit model. More complex models may be employed for greater accuracy. Any model or calculation method that fits the circuit configuration of the pixel driving circuit and the characteristics of its circuit elements may be used, provided the threshold voltage Vth is calculated from the time taken for the output terminal voltage to reach the reference voltage.

Those skilled in the art will recognize that further variations are possible within the scope of the invention, which is defined in the appended claims.

What is claimed is:

1. A method of measuring the threshold voltage of a driving element in a pixel including the driving element, a light emitting element that receives current from the driving element, and a capacitor that controls the driving element, the method comprising:
charging the capacitor to an initial voltage that turns on the driving element;
allowing the capacitor to discharge through the driving element;
measuring time that elapses until the capacitor reaches a reference voltage intermediate between the initial voltage and the threshold voltage; and
calculating the threshold voltage from the elapsed time.

2. The method of claim 1, wherein the driving element has a control terminal and a current output terminal, the current output terminal being connected to the light emitting element, the capacitor being connected between the control terminal and the current output terminal.

3. The method of claim 1, wherein the driving element is an amorphous silicon thin-film transistor.

4. The method of claim 1, wherein calculating the threshold voltage further comprises using a resistor-capacitor circuit model.

5. The method of claim 1, wherein the pixel is connected to an output terminal of a driving circuit, and:
charging the capacitor further comprises charging the capacitor from the output terminal;
allowing the capacitor to discharge further comprises placing the output terminal in a high-impedance state; and
measuring the time further comprises measuring the time that elapses until the output terminal reaches the reference voltage.

6. The method of claim 5, wherein measuring the time further comprises:
comparing a voltage at the output terminal with the reference voltage; and
counting clock pulses until the voltage at the output terminal reaches the reference voltage.

7. The method of claim 6, wherein comparing the voltage at the output terminal with the reference voltage further comprises:
using a voltage follower receiving an inverting input voltage from the output terminal and normally providing an output voltage to the output terminal;
disconnecting the output voltage of the voltage follower from the output terminal; and
supplying the reference voltage as a non-inverting input voltage to the voltage follower.

8. The method of claim 7, wherein comparing the voltage at the output terminal with the reference voltage further comprises:
latching successive counts of the clock pulses in a data latch; and
using the output of the voltage follower as a latch enable input signal for the data latch.

9. A method of driving a pixel including a driving element, a light emitting element that receives current from the driving element, and a capacitor that controls the driving element, the method comprising:
measuring a threshold voltage of the driving element by the method of claim 1;
receiving a display data value;
correcting the display data value according to the measured threshold value of the driving element to generate a gradation value;
generating a gradation voltage from the gradation value;
charging the capacitor to the gradation voltage; and
supplying the current from the driving element to the light emitting element at a rate responsive to the gradation voltage in the capacitor.

10. A display driver for driving pixels in a display panel, each pixel including a capacitor that is charged or discharged by a gradation voltage, a driving element that supplies current responsive to the charge stored in the capacitor, and a light emitting element that emits light responsive to the current supplied by the driving element, the driving element having a threshold voltage, the display driver comprising:
an output terminal for supplying the gradation voltage to the capacitor;
an initial voltage generator for generating an initial voltage and supplying the initial voltage from the output terminal to the capacitor from a first time to a second time, then halting supply of the initial voltage at the second time to allow the capacitor to discharge through the driving element;
a measuring circuit for measuring elapsed time from the second time until the output terminal reaches a reference voltage intermediate between the initial voltage and the threshold voltage; and
a threshold voltage calculator for calculating the threshold value of the driving element from the elapsed time measured by the measuring circuit.

11. The display driver of claim 10, further comprising a correction processor for correcting the gradation voltage supplied to the capacitor according to the calculated threshold value.

12. The display driver of claim 10, wherein the measuring circuit further comprises:
a comparator for receiving an output terminal voltage from the output terminal, comparing the reference voltage and the output terminal voltage, outputting a first output signal when the output terminal voltage is between the initial voltage and the reference voltage, and outputting a second output signal when the reference voltage is between the initial voltage and the output terminal voltage; and
a counter for receiving the first and second output signals and a clock signal, counting the clock signal while the first output signal is received, and outputting a counting result to indicate the elapsed time when the second output signal is received.

13. The display driver of claim 10, wherein the initial voltage generator includes a plurality of output terminals for supplying gradation voltages to the capacitors in different pixels, and the initial voltage generator further comprises:
a plurality of voltage followers having respective inverting input terminals connected to respective ones of the output terminals, for output of the gradation voltages and the initial voltage; and
a plurality of switches for supplying the gradation voltages and the initial voltage from the voltage followers to the output terminals, the switches being closed to supply the initial voltage to the output terminals from the first time to the second time and opened to stop supplying the initial voltage to the output terminals at the second time.

14. The display driver of claim 13, wherein the voltage followers have respective non-inverting input terminals that begin receiving the reference voltage at the second time, each voltage follower generating a first output signal when its non-inverting input terminal is at a higher voltage level than its inverting input terminal and generating a second output signal when its non-inverting terminal is at a lower voltage level than its inverting input terminal, the measuring circuit further comprising:
a second counter for counting a clock signal and outputting a counting result; and
a latch coupled to the second counter, having storage cells coupled to respective ones of the voltage followers for latching the counting result while the first output signal is received, holding the latched counting result while the second output signal is received, and supplying the held calculation result to the threshold voltage calculator to indicate the elapsed time.

15. The display driver of claim 10, wherein the threshold voltage calculator uses a resistor-capacitor circuit model to calculate the threshold value.

16. The display driver of claim 10, wherein the driving element has a control terminal and a current output terminal, the current output terminal being connected to the light emitting element, the capacitor being connected between the control terminal and the current output terminal.

17. The display driver of claim 10, wherein the driving element is an amorphous silicon thin-film transistor.
